(19) United States
(12) Patent Application Publication
(10) Pub. No.: US 2016/0311456 A1
(43) Pub. Date: Oct. 27, 2016

(54) Safety Stroller Handle For Baby Strollers

(71) Applicant: Henry R. Schuman, Farmingville, NY (US)

(72) Inventor: Henry R. Schuman, Farmingville, NY (US)

(21) Appl. No.: 14/692,941

(22) Filed: Apr. 22, 2015

(51) Int. Cl. B62B 9/24

(52) U.S. Cl. CPC B62B 9/245

(57) ABSTRACT

The invention that will be patented is a side safety handle for a baby stroller for walking safety across an intersection. Currently when walking a child across the road, the child is pushed in a stroller in front of the adult or held by the hand on the side of the adult. The baby stroller safety handle puts the child on the side of the adult without first putting the child into the intersection. By doing this, the child is not put into danger and gives the adult the correct perspective to cross the intersection safely with the child. The safety stroller handle can be integrated into the stroller or can be added on to any stroller by the consumer. The device that I have made, shows a safety handle connected to an umbrella stroller which puts the child on the side of the adult so the adult and child can cross an intersection safely.

The invention that I will be patenting is a side safety handle for a baby stroller for walking safely across an intersection. Currently when walking a child across the road, the child is pushed in a stroller in front of the adult or held by the hand on the side of the adult. The baby stroller safety handle puts the stroller on the side of the adult without first putting the child into the intersection. By doing this, the child is not put into danger and gives the adult the correct perspective to cross the intersection safely with the child. The safety stroller handle can be intearated into the stroller or can be added on to an stroller by the consumer. The device that I have made shows a safety handle connected to an umbrella stroller which puts the child on the side of the adult so the adult and child can cross an intersection safely.

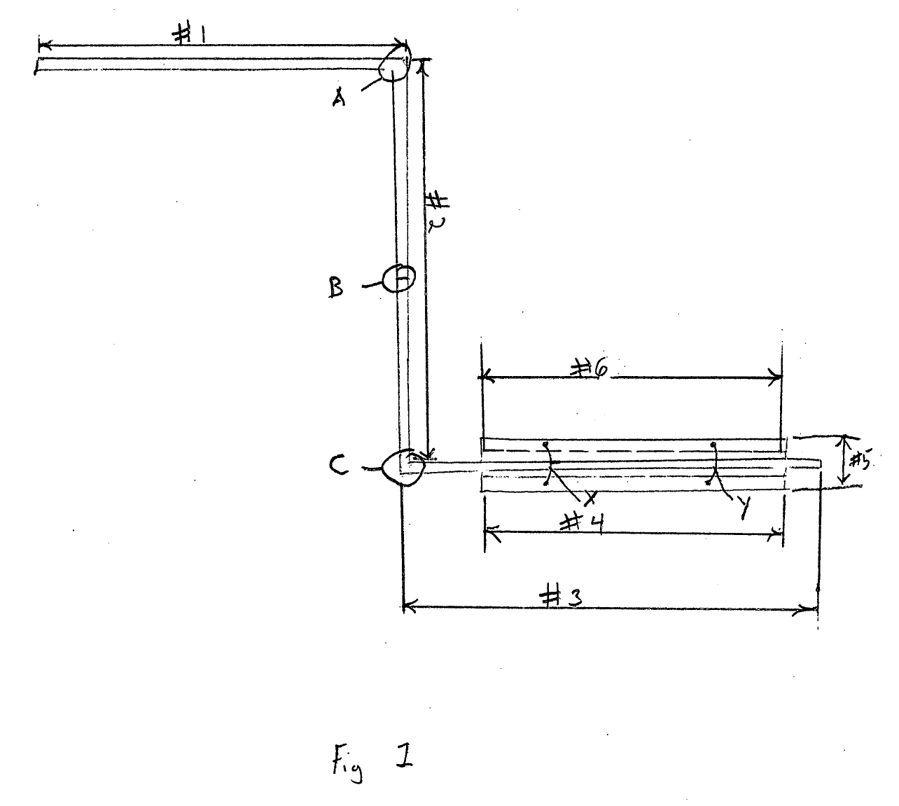

FIG. 1

Numbers 1, 2 and 3 shows the dimensions of the bar of the handle. The dimensions can be from 18″ to 24″ depending on the stroller application (stroller model). The letters A, B and C represent the hinge points or fix points of the safety stroller handle. Whether or not to hinge the safety stroller handle at these points also depends on the stroller application. The hinged point(s) will allow the handle to fold up when not in use. The #4 and #5 represent the dimension of the flat steel that supports the safety stroller handle. #6 represents the bushing that the safety stroller handle fit into. The letters X and Y represent the fasteners that hold the safety stroller handle to the flat steel support.

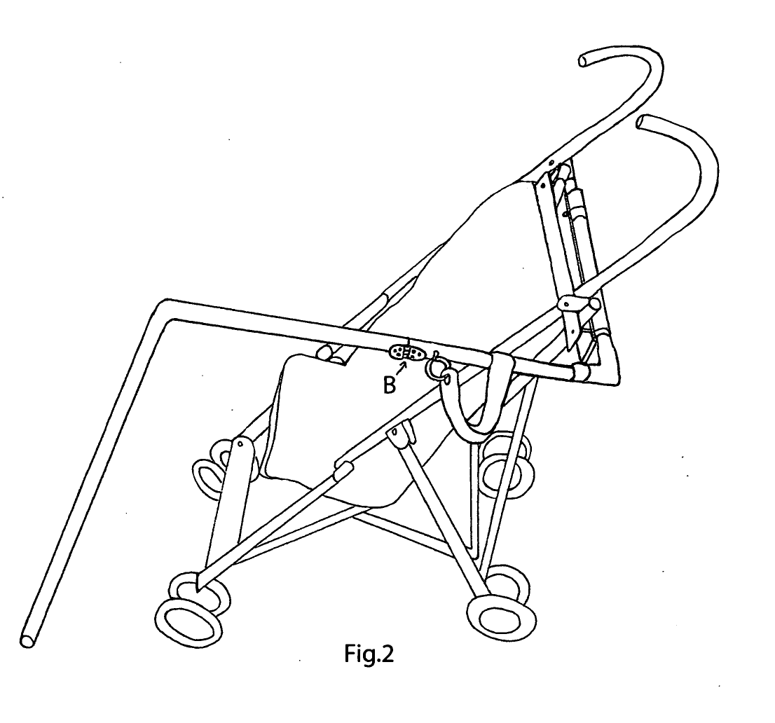

FIG. 2

This figure demonstrates an umbrella stroller with the safety stroller handle fully extended with a hinge point at B as represented in FIG. 1.

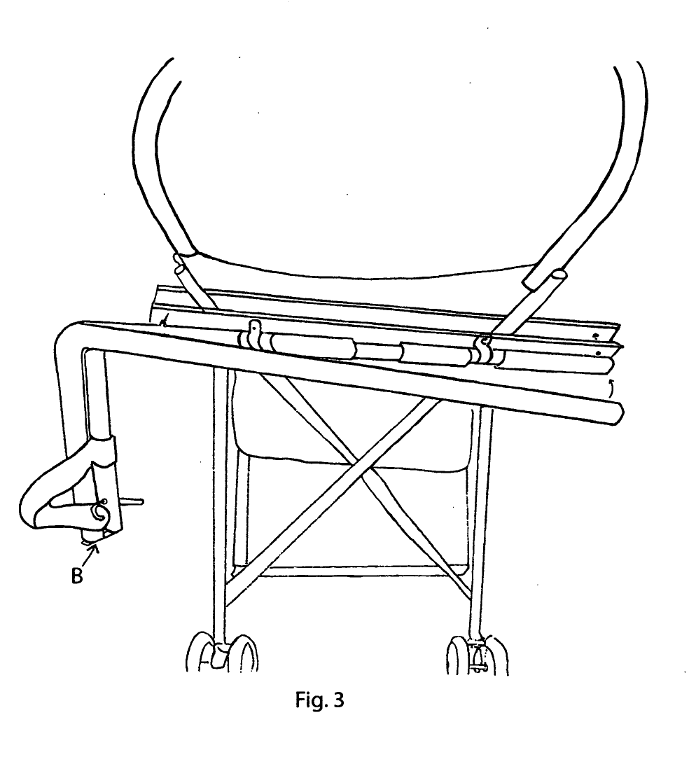

FIG. 3

This figure demonstrates an umbrella stroller with the stroller handle folded behind the stroller when not in use.

1. The invention that will be patented is a side safety handle for a baby stroller for walking safety across an intersection. Currently when walking a child across the road, the child is pushed in a stroller in front of the adult or held by the hand on the side of the adult. The baby stroller safety handle puts the child on the side of the adult without first putting the child into the intersection. By doing this, the child is not put into danger and gives the adult the correct perspective to cross the intersection safely with the child.
